(19) United States
(12) Patent Application Publication
(10) Pub. No.: US 2025/0158974 A1
(43) Pub. Date: May 15, 2025

(54) NF CONSUMER AUTHENTICATION WITH MODEL-D INDIRECT COMMUNICATION

(71) Applicant: Cisco Technology, Inc., San Jose, CA (US)

(72) Inventor: Jis Abraham, Bangalore (IN)

(21) Appl. No.: 18/506,840

(22) Filed: Nov. 10, 2023

(51) Int. Cl. H04L 9/40

(52) U.S. Cl. CPC H04L 63/0807; H04L 63/0884

(57) ABSTRACT

NF Consumer authorization with model-D indirect communication between NF Consumer and NF Producer is a big challenge, as the number of SCPs in the network are typically very small compared to the number of NFs. The concepts disclosed herein optimize the NF Consumer authorization with model-D indirect communication, and allow the SCP to handle authorization for large numbers of NFs and slices per NFs without the strain on the SCP. The concepts disclosed further permit a NF Consumer to reuse an access token for different sessions, while reducing the resource requirements on the SCP.

### BACKGROUND

Fifth generation (5G) mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces.

In 5G mobile and wireless networks and any other networks, authentication may be required for different Network Functions (NFs) to communicate (e.g., between a NF Consumer and a NF Service Producer). The authentication framework defined by 3GPP allows NF Producers to authorize requests from NF Consumers. This authorization framework uses the OAuth 2.0 framework to grant access to the NF Producers, and may use a Network Repository Function (NRF) as the authentication server. Grants are of the type Client Credentials Grant, and Access tokens are JSON Web Tokens and are secured with digital signatures or Message Authentication Codes (MAC) based on JSON Web Signature (JWS).

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture in accordance with some embodiments;

FIG. 1B illustrates an example fog computing architecture in accordance with some embodiments;

FIG. 2 illustrates an exemplary schematic representation of a 5G network environment in which network slicing has been implemented, and in which one or more aspects of the present disclosure may operate;

FIGS. 3A and 3B illustrate an example consumer NF authentication with direct communication in accordance with some embodiments;

FIG. 4 illustrates an example consumer NF authentication with model-d indirect communication in accordance with some embodiments;

FIG. 5 illustrates an exemplary mechanism for access token retrieval with model-d indirect communication in accordance with some embodiments;

FIG. 6 illustrates an exemplary flowchart providing a method of consumer NF authentication with model-D indirect communication in accordance with some embodiments;

FIG. 7 shows an example of computing system 700, which can be for example any computing device that can implement components of the system in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

In some aspects, the techniques described herein relate to a method including: generating, by a Network Function (NF) consumer, a token profile identifier (TokenProfileId) parameter for a set of access token request (AccessTokenRequest) parameters; sending, by the NF consumer, a service request for a NF producer to a service communication proxy (SCP), wherein the service request includes a set of network repository function (NRF) discovery parameters, the set of AccessTokenRequest parameters, and the TokenProfileId parameter; receiving, by the SCP, an access token (AccessToken) for the NF producer from a NRF based on the set of NRF discovery parameters and the set of AccessTokenRequest parameters; storing, in the SCP, the AccessToken for the NF consumer and an access token profile (AccessTokenProfile) for the NF producer; receiving, by the SCP, a subsequent service request from the NF consumer to the NF producer; and retrieving, by the SCP, the AccessToken for the subsequent service request based on the AccessTokenProfile.

In some aspects, the techniques described herein relate to a system including: a storage configured to store instructions; a processor configured to execute the instructions and cause the processor to: generate, by a Network Function (NF) consumer, a token profile identifier (TokenProfileId) parameter for a set of access token request (AccessTokenRequest) parameters; send, by the NF consumer, a service request for a NF producer to a service communication proxy (SCP), wherein the service request includes a set of network repository function (NRF) discovery parameters, the set of AccessTokenRequest parameters, and the TokenProfileId parameter; receive, by the SCP, an access token (AccessToken) for the NF producer from a NRF based on the set of NRF discovery parameters and the set of AccessTokenRequestparameters; store, in the SCP, the AccessToken for the NF consumer and an access token profile (AccessTokenProfile) for the NF producer; receive, by the SCP, a subsequent service request from the NF consumer to the NF producer; and retrieve, by the SCP, the AccessToken for the subsequent service request based on the AccessTokenProfile.

In some aspects, the techniques described herein relate to a non-transitory computer readable medium including instructions, the instructions, when executed by a computing system, cause the computing system to: generate, by a Network Function (NF) consumer, a token profile identifier (TokenProfileId) parameter for a set of access token request (AccessTokenRequest) parameters; send, by the NF consumer, a service request for a NF producer to a service communication proxy (SCP), wherein the service request includes a set of network repository function (NRF) discovery parameters, the set of AccessTokenRequest parameters, and the TokenProfileId parameter; receive, by the SCP, an access token (AccessToken) for the NF producer from a NRF based on the set of NRF discovery parameters and the set of AccessTokenRequest parameters; store, in the SCP, the AccessToken for the NF consumer and an access token profile (AccessTokenProfile) for the NF producer; receive, by the SCP, a subsequent service request from the NF consumer to the NF producer; and retrieve, by the SCP, the AccessToken for the subsequent service request based on the AccessTokenProfile.

### Example Embodiments

The disclosed technology addresses the need in the art for federating SaaS providers with enterprises across network slices. Additionally, the disclosed technology address the need in the art for federating SaaS providers with enterprises across network slices in order to manage SaaSs provided by the SaaS providers to the enterprises. The present technology involves system, methods, and computer-readable media federating SaaS providers with enterprises across network slices used to provision SaaSs to the enterprises by the SaaS providers. Additionally, the present technology involves systems, methods, and computer-readable media for federating SaaS providers with enterprises across network slices in order to manage SaaSs provisioned by the SaaS providers to the enterprises across the network slices.

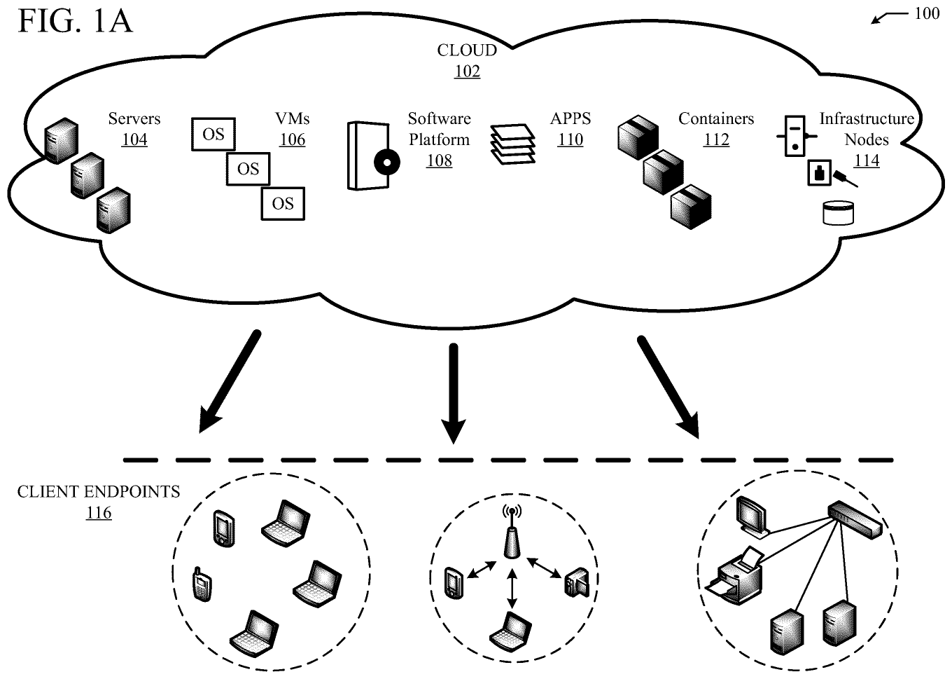

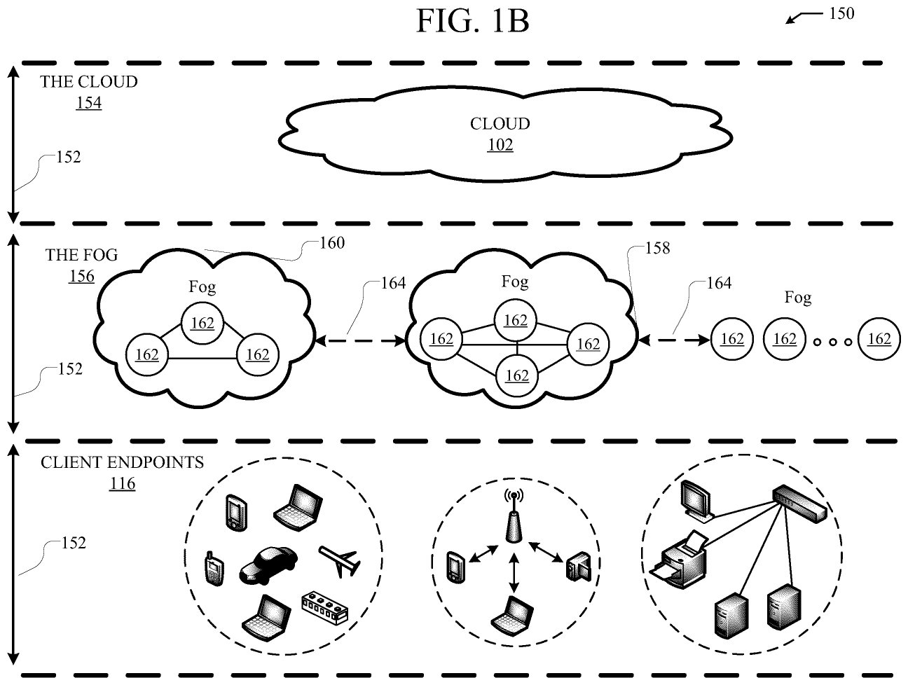

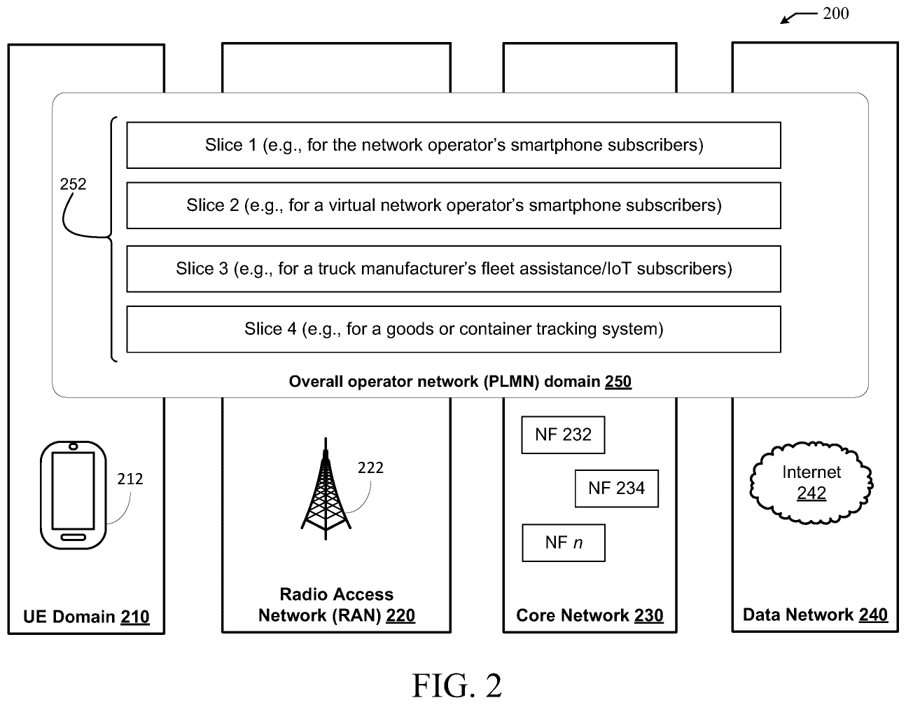

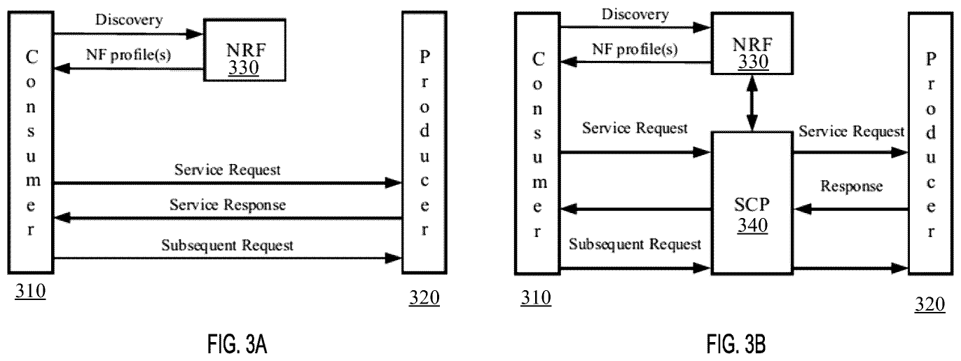

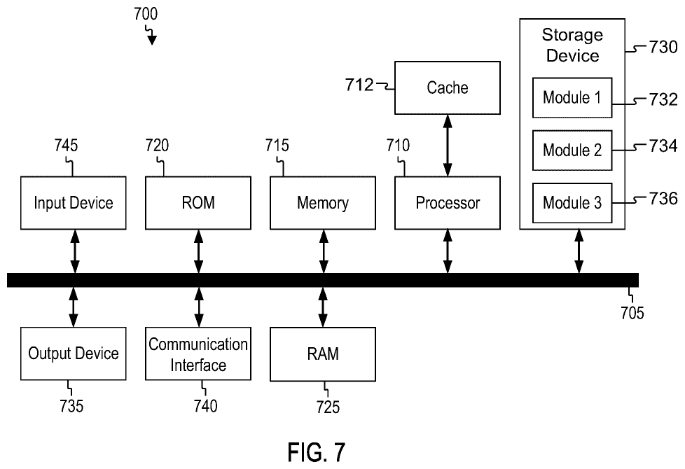

A description of network environments and architectures for network data access and services, as illustrated in FIGS. 1A, 1B, and 2 is first disclosed herein. A discussion of systems, methods, and computer-readable medium for federating enterprises and SaaS providers using network slices, as shown in FIGS. 3-6, will then follow. The discussion then concludes with a brief description of example devices, as illustrated in FIGS. 7 and 8. These variations shall be described herein as the various embodiments are set forth. The disclosure now turns to FIG. 1A.

FIG. 1A illustrates a diagram of an example cloud computing architecture 100. The architecture can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 158 can be local or regional clouds or networks. For example, the fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud 154 while located at the starting location and switch to a different physical and/or logical connection point with the cloud 154 while located at the destination location. The particular fog node can thus move within particular clouds and/or fog instances and, therefore, serve endpoints from different locations at different times.

FIG. 2 depicts an exemplary schematic representation of a 5G network environment 200 in which network slicing has been implemented, and in which one or more aspects of the present disclosure may operate. As illustrated, network environment 200 is divided into four domains, each of which will be explained in greater depth below; a User Equipment (UE) domain 210, e.g. of one or more enterprise, in which a plurality of user cellphones or other connected devices 212 reside; a Radio Access Network (RAN) domain 220, in which a plurality of radio cells, base stations, towers, or other radio infrastructure 222 resides; a Core Network 230, in which a plurality of Network Functions (NFs) 232, 234, . . . , n reside; and a Data Network 240, in which one or more data communication networks such as the Internet 242 reside. Additionally, the Data Network 240 can support SaaS providers configured to provide SaaSs to enterprises, e.g. to users in the UE domain 210.

Core Network 230 contains a plurality of Network Functions (NFs), shown here as NF 232, NF 234 . . . NF n. In some embodiments, core network 230 is a 5G core network (5GC) in accordance with one or more accepted 5GC architectures or designs. In some embodiments, core network 230 is an Evolved Packet Core (EPC) network, which combines aspects of the 5GC with existing 4G networks. Regardless of the particular design of core network 230, the plurality of NFs typically execute in a control plane of core network 230, providing a service based architecture in which a given NF allows any other authorized NFs to access its services. For example, a Session Management Function (SMF) controls session establishment, modification, release, etc., and in the course of doing so, provides other NFs with access to these constituent SMF services.

In some embodiments, the plurality of NFs of core network 230 can include one or more Access and Mobility Management Functions (AMF; typically used when core network 230 is a 5GC network) and Mobility Management Entities (MME; typically used when core network 230 is an EPC network), collectively referred to herein as an AMF/MME for purposes of simplicity and clarity. In some embodiments, an AMF/MME can be common to or otherwise shared by multiple slices of the plurality of network slices 252, and in some embodiments an AMF/MME can be unique to a single one of the plurality of network slices 252.

The same is true of the remaining NFs of core network 230, which can be shared amongst one or more network slices or provided as a unique instance specific to a single one of the plurality of network slices 252. In addition to NFs comprising an AMF/MME as discussed above, the plurality of NFs of the core network 230 can additionally include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across these four domains of the 5G network environment 200, an overall operator network domain 250 is defined. The operator network domain 250 is in some embodiments a Public Land Mobile Network (PLMN), and can be thought of as the carrier or business entity that provides cellular service to the end users in UE domain 210. Within the operator network domain 250, a plurality of network slices 252 are created, defined, or otherwise provisioned in order to deliver a desired set of defined features and functionalities, e.g. SaaSs, for a certain use case or corresponding to other requirements or specifications. Note that network slicing for the plurality of network slices 252 is implemented in end-to-end fashion, spanning multiple disparate technical and administrative domains, including management and orchestration planes (not shown). In other words, network slicing is performed from at least the enterprise or subscriber edge at UE domain 210, through the Radio Access Network (RAN) 120, through the 5G access edge and the 5G core network 230, and to the data network 240. Moreover, note that this network slicing may span multiple different 5G providers.

For example, as shown here, the plurality of network slices 252 include Slice 1, which corresponds to smartphone subscribers of the 5G provider who also operates network domain, and Slice 2, which corresponds to smartphone subscribers of a virtual 5G provider leasing capacity from the actual operator of network domain 250. Also shown is Slice 3, which can be provided for a fleet of connected vehicles, and Slice 4, which can be provided for an IoT goods or container tracking system across a factory network or supply chain. Note that these network slices 252 are provided for purposes of illustration, and in accordance with the present disclosure, and the operator network domain 250 can implement any number of network slices as needed, and can implement these network slices for purposes, use cases, or subsets of users and user equipment in addition to those listed above. Specifically, the operator network domain 250 can implement any number of network slices for provisioning SaaSs from SaaS providers to one or more enterprises.

5G mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous generation architectures.

Within the scope of the 5G mobile and wireless network architecture, a network slice comprises a set of defined features and functionalities that together form a complete Public Land Mobile Network (PLMN) for providing services to UEs. This network slicing permits for the controlled composition of a PLMN with the specific network functions and provided services that are required for a specific usage scenario. In other words, network slicing enables a 5G network operator to deploy multiple, independent PLMNs where each is customized by instantiating only those features, capabilities and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g. based on requirements of the services, to the enterprise.

Associating SaaSs and SaaS providers with network slices used to provide the SaaSs to enterprises can facilitate efficient management of SaaS provisioning to the enterprises. Specifically, it is desirable for an enterprise/subscriber to associate already procured SaaSs and SaaS providers with network slices actually being used to provision the SaaSs to the enterprise. However, associating SaaSs and SaaS providers with network slices is extremely difficult to achieve without federation across enterprises, network service providers, e.g. 5G service providers, and SaaS providers.

As mentioned above, a given NF may allow other NFs to access its services once they are authorized. The authorization framework defined by 3GPP allows NF Producers to authorize the requests from NF Consumers. The authorization framework uses the OAuth 2.0 framework. Grants are of the type Client Credentials Grant and Access tokens are JSON Web Tokens and are secured with digital signatures or Message Authentication Codes (MAC) based on JSON Web Signature (JWS). In some instances, the Network Repository Function (NRF) acts as the OAuth 2.0 Authorization server. Generally, NRF and NF Producers are expected to use pre-shared symmetric key for this approach. Generally, the NF Consumer is the OAuth 2.0 client and it uses a NFInstanceId as a clientId during NfRegister with NRF. The NF Producer is an OAuth 2.0 resource server and it includes allowed service operations and resources per NF Consumer type while registering with the NRF. Additionally, when an access token is fetched from NRF, the access token request is based on a number of access token request parameters, such as consumer instanceId, producer instanceId, slice-id, Fqdn, NfType, services, etc.

In general, NF Consumer authentication can be made with direct communication between NF Consumer and NF Producer or with model-D indirect communication between NF Consumer and NF Producer. FIG. 3A illustrates NF Consumer authentication with direct communication and FIG. 3B illustrates NF Consumer authentication with model-d indirect communication.

As shown in FIG. 3A, with direct communication, when NF Consumer 310 wants to talk to NF Producer 320, NF Consumer 310 sends a discovery request to NRF 330 to retrieve NFs that match the discovery parameters included in the discovery request. NF Consumer 310 selects one of the NFs (e.g., NF Producer 320) from the list of target NFs returned by the NRF 330. NF Consumer then retrieves an access token for the NF Producer 320 from NRF 330 and uses the access token while communicating with NF Producer 320. Access token is cached and is used for the validity duration across all the sessions that results in NF Consumer 310 to NF Producer 320 communication.

As shown in FIG. 3B, with model-D indirect communication, there is no direct communication between NF Consumer 310 and NF Producer 320. Instead, NF Consumer 310 talks to a service communication proxy (SCP) 340, and the SCP 340 performs the query of NRF 330 and selection of the NF Producer 320. Thus, there is no way for NF Consumer 310 to request for an access token for authorization from NF Producer 320 when indirect communication is used by the NFs.

As FIG. 3B illustrates, NF Consumer 310 sends the service request to SCP 340. SCP 340 discovers NF Producer 320, retrieves the access token for NF Producer 320, and then sends the service request to NF Producer 320 with the access token. SCP 340 includes the access token in service response back to NF Consumer 310. With model-D indirect communication, NF Consumer 310 can cache this access token and use it for all messages from NF Consumer 310 to NF Producer 320 for that session. However, for new sessions, NF Consumer 310 cannot use the cached access token, as NF Consumer 310 is not aware which NF Producer 320 is going to get selected in the new session. In other words, SCP 340 has to perform a new access token request for every session.

Indeed, this is one of the primary challenges associated with model-D indirect communication. In particular, even though the SCP 340 can return the access token back to NF Consumer 310 in the service response, NF Consumer 310 will not be able to use this access token for other sessions because NF Consumer 310 does not know which NF Producer 320 instance is going to get selected for other sessions. Additionally, load balancing among NF Producer 320 instances is the responsibility of the SCP 340. Thus, NF Consumer 310 cannot simply ask SCP 340 to use a NF Producer 320 instance and access token selected for the first session for other sessions. Because of this challenge, SCP 340 is required to do an access token request for every session, which is not scalable from the SCP 340 perspective as the SCP 340 caters to many different NFs in the network. Additionally, caching the access token and access token request in the SCP 340 is not a scalable approach because as discussed above, each access token request is based on a large number of parameters. For example, most access token requests have upwards of 12 unique parameters per access token request. Thus, the SCP 340 would be required to cache each access token based on each unique set of access token request parameters (e.g., consumerId, producerId, scope, plmn, nssai, nfSet, slice-id, Fqdn, NfType, services, etc.), which requires a significant amount of resources of the SCP 340 and significantly impacts the performance of SCP 340.

In other words, NF Consumer authorization with model-D indirect communication between NF Consumer and NF Producer is a big challenge, as the number of SCPs in the network are typically very small compared to the number of NFs. Additionally, the number of enterprises/slices handled by each NF is very huge. Both these are inputs are used for generating access tokens for authorization. The SCP handling the authorization for huge number of NFs and slices per NFs is almost impossible. Thus, there is a need for a system and method that allows a NF Consumer to reuse an access token while reducing the resource requirements on SCP to handle NF Consumer authorization with model-D indirect communication.

To solve this problem, the concepts disclosed permit a NF Consumer to reuse an access token for different sessions, while reducing the resource requirements on the SCP. The concepts disclosed herein optimize the NF Consumer authorization with model-D indirect communication, and allow the SCP to handle authorization for large numbers of NFs and slices per NFs without the strain on the SCP.

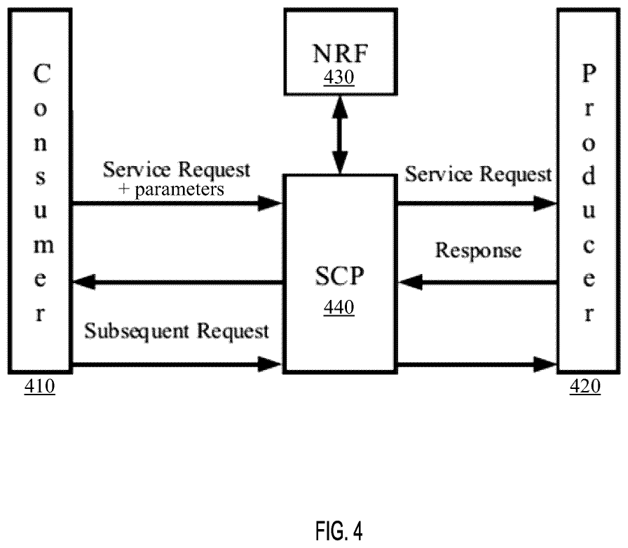

FIG. 4 illustrates NF Consumer authentication with model-D indirect communication in accordance with some embodiments. As shown, the NF Consumer 410 sends a service request including at least a set of parameters (e.g., discovery parameters, access token request parameters, etc.) to a SCP 440. SCP 440 does NRF 430 discovery based on the discovery parameters to discover NF Consumer 410 and select NF Producer 420, followed by SCP 440 sending the access token request parameters to NRF 430. SCP 440 includes the NF Producer 420 identifier instance of the selected NF Producer 420 in the access token request. The SCP 440 then sends the service request and access token to the NF Producer 420, which is validated by the NF Producer 420. NF Producer 420 then sends a response back to SCP 440 to be sent back to NF Consumer 410.

The NF Consumer 410 also generates a new parameter for inclusion with the service request to SCP 440. In particular, NF Consumer 410 generates a Token Profile identifier (TokenProfileId) parameter per set of access token request parameters. The NF Consumer 410 will use the same TokenProfileId with the same set of access token request parameters, and includes the TokenProfileId with each access token request.

The SCP 440 stores the access token for each NF Consumer 410 and an access token profile for each NF Producer 420. The access token profile for each NF Producer 420 may include a NF Consumer identifier (consumerId), a NF Producer identifier (producerId), and the TokenProfileId based on the access token request parameters. Thus, the SCP will maintain a mapping such as {consumerId, producerId, TokenProfileId}<==>{accessToken, expiry}, where expiry is the expiration of the access token.

Thus, when a subsequent request having the same access token request parameters is sent from NF Consumer 410 to SCP 440, the same TokenProfileId will be sent to the SCP 440. The SCP 440 can then retrieve the correct access token based on the access token profile for the NF Producer 420 sought by NF Consumer 410, and thus does not require locating and acquiring a new access token for the new, subsequent session. Furthermore, as the SCP 440 only stores the access token for the NF Consumer 410 and the access token profile having only three parameters for each NF Producer 420, the required resources and performance impact on the SCP 440 is significantly reduced.

To illustrate, if the SCP 440 were to cache the access token request parameters for each service request and associate them with each access token, the SCP 440 would be required to cache upwards of twelve parameters per NF Producer 420. If five NF Producers were accessed, the SCP 440 would be required to cache a minimum of twelve parameters per NF Producer, requiring significant resources and negatively impacting the performance of the SCP 440. However, with the concepts disclosed herein, the SCP 440 only needs to store three parameters per NF Producer 420, namely consumerId, producerId, and TokenProfileId. If five NF Producers were accessed, the SCP 440 would then only need to store the following mapping: {consumerId1, producerId1, TokenProfileId1}<==>{accessToken1, expiry}; {consumerId1, producerId2, TokenProfileId1}<==>{accessToken2, expiry}; . . . {consumerId1, producerIdn, TokenProfileId1}<==>{accessTokenn, expiry}. Thus, the SCP 440 can reuse any of the stored access tokens that correspond to the same TokenProfileId and consumerId.

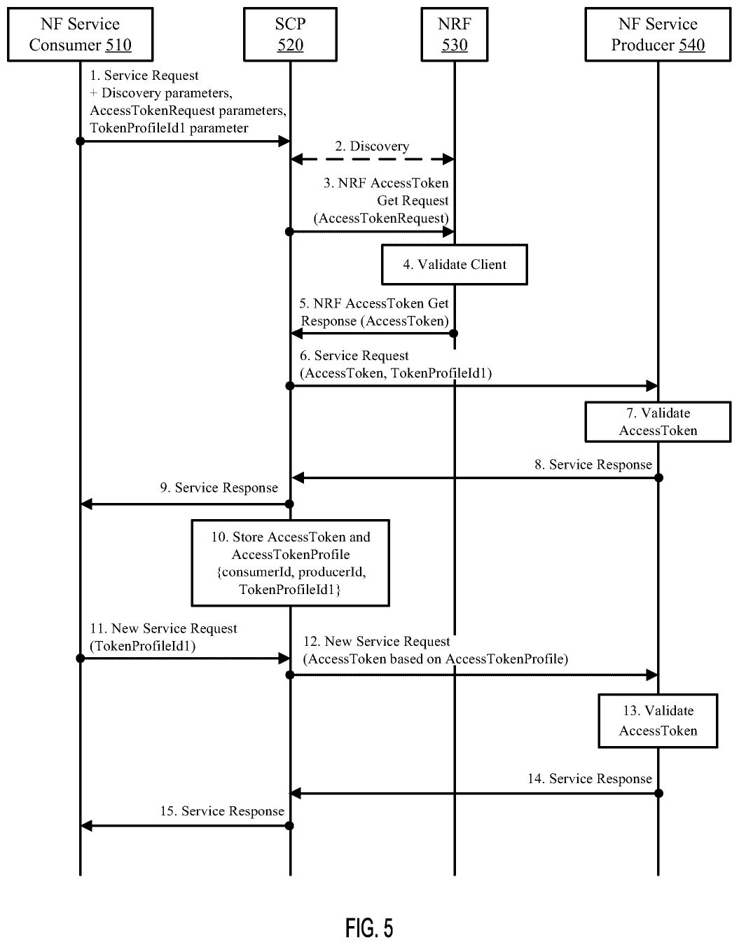

To illustrate these concepts, FIG. 5 illustrates exemplary mechanism for access token retrieval with model-d indirect communication in accordance with some embodiments. In particular, FIG. 5 illustrates lines 1-10 for a service request from NF Consumer 510 to NF Producer 540 for a first session, then a subsequent service request for a second session at lines 11-15. At line 1, the NF Consumer 510 sends a service request and a set of parameters, including discovery parameters, AccessTokenRequest parameters, and the TokenProfileId parameter, to SCP 520. At line 2, SCP 520 communicates with NRF 530 to discover the NF Consumer 510 and target NF Producer 540 using the discovery parameters. At line 3, the SCP 520 sends the NRF AccessToken get/fetch request with the AccessTokenRequest parameters to NRF 530 for validation. At line 4, the NRF 530 validates the client based on the AccessTokenRequest parameters, and at line 5, sends a NRF AccessToken get/fetch response having the AccessToken for the NF Producer 540. At line 6, the SCP 520 then sends the service request, AccessToken, and TokenProfileId to the NF Producer 540. At line 7, the NF Producer 540 validates the AccessToken, and at line 8, sends the service response back to SCP 520. At line 9, the SCP 520 sends the service response back to the NF Consumer 510, thus enabling the NF Consumer 510 and NF Producer 540 to talk for the duration of the session. Critically, at like 10, the SCP 520 then stores the AccessToken for the NF Consumer 510 and the AccessTokenProfile (e.g., the consumerId, producerId, and TokenProfileId) for the NF Producer 540. Thus, for this same session, the

[symbol]

Thus, at line 11, when NF Consumer 510 begins a subsequent new session that includes the same AccessTokenRequest parameters as the first session, the NF Consumer 510 sends the TokenProfileId along with the new service request to the SCP 520. The SCP 520 uses the stored mapping of the AccessTokenProfile and received TokenProfileId to identify and retrieve the correct AccessToken for the NF Producer 540. Thus, at line 12, the SCP 520 may then send the AccessToken retrieved with the new service request for the different session to the NF Producer 540. The NF Producer 540 is then able to validate the AccessToken at line 13, and send back a service response to SCP 520 at line 14 to then be delivered back to NF Consumer 510 at line 15. As such, the SCP 520 was capable of reusing the same AccessToken stored for the NF Producer 540 and thus does not require new access tokens for new sessions. Further, the SCP 520 memory resource requirement comes down significantly. Furthermore, this solution helps retain the NF selection logic at the SCP (for load balancing).

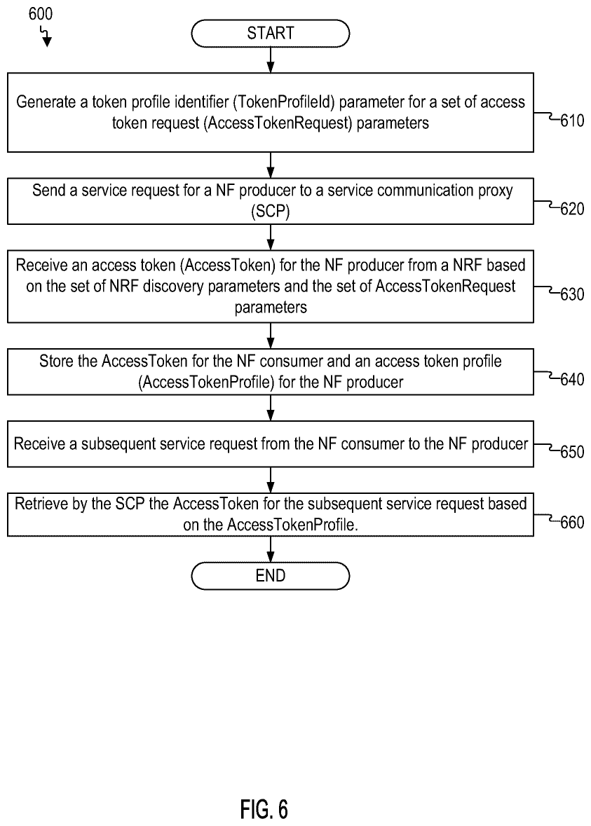

FIG. 6 illustrates an example method 600 for NF Consumer authentication with model-d indirect communication. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method includes generating a token profile identifier (TokenProfileId) parameter for a set of access token request (AccessTokenRequest) parameters at block 610. For example, at least one of the NFs illustrated in FIG. 2 may generate a token profile identifier (TokenProfileId) parameter for a set of access token request (AccessTokenRequest) parameters.

According to some examples, the method includes sending a service request for a NF producer to a service communication proxy (SCP) at block 620. For example, at least one of the the NFs illustrated in FIG. 2 may send a service request for a NF producer to a service communication proxy (SCP). The service request may include a set of network repository function (NRF) discovery parameters, the set of AccessTokenRequest parameters, and the TokenProfileId parameter.

According to some examples, the method includes receiving an access token (AccessToken) for the NF producer from a NRF based on the set of NRF discovery parameters and the set of AccessTokenRequest parameters at block 630. For example, the SCP 440 illustrated in FIG. 4 may receive an access token (AccessToken) for the NF producer from a NRF based on the set of NRF discovery parameters and the set of AccessTokenRequest parameters.

According to some examples, the method includes storing the AccessToken for the NF consumer and an access token profile (AccessTokenProfile) for the NF producer in the SCP at block 640. For example, the SCP 440 illustrated in FIG. 4 may store the AccessToken for the NF consumer and an access token profile (AccessTokenProfile) for the NF producer. The AccessTokenProfile may include a consumer identifier (ConsumerId) parameter, a producer identifier (ProducerId) parameter, and the TokenProfileId.

According to some examples, the method includes receiving a subsequent service request from the NF consumer to the NF producer by the SCP at block 650. For example, the SCP 440 illustrated in FIG. 4 may receive a subsequent service request from the NF consumer to the NF producer. The subsequent service request may include the same set of AccessTokenRequest parameters.

According to some examples, the method includes retrieving the AccessToken for the subsequent service request based on the AccessTokenProfile at block 660. For example, the SCP 440 illustrated in FIG. 4 may retrieve the AccessToken for the subsequent service request based on the AccessTokenProfile. Thus, the same AccessToken may be used to authenticate the NF Consumer for communication with the NF Producer as described above.

FIG. 7 shows an example of computing system 700, which can be for example any computing device making up [symbol] or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Aspect 1. A method comprising: generating, by a Network Function (NF) consumer, a token profile identifier (TokenProfileId) parameter for a set of access token request (AccessTokenRequest) parameters; sending, by the NF consumer, a service request for a NF producer to a service communication proxy (SCP), wherein the service request includes a set of network repository function (NRF) discovery parameters, the set of AccessTokenRequest parameters, and the TokenProfileId parameter; receiving, by the SCP, an access token (AccessToken) for the NF producer from a NRF based on the set of NRF discovery parameters and the set of AccessTokenRequest parameters; storing, in the SCP, the AccessToken for the NF consumer and an access token profile (AccessTokenProfile) for the NF producer; receiving, by the SCP, a subsequent service request from the NF consumer to the NF producer; and retrieving, by the SCP, the AccessToken for the subsequent service request based on the AccessTokenProfile.

Aspect 2. The method of Aspect 1, wherein the AccessTokenProfile includes a consumer identifier (ConsumerId) parameter, a producer identifier (ProducerId) parameter, and the TokenProfileId.

Aspect 3. The method of any of Aspects 1 to 2, wherein the subsequent service request includes the same set of AccessTokenRequest parameters as the service request.

Aspect 4. The method of any of Aspects 1 to 3, wherein storing the AccessToken for the NF consumer and the AccessTokenProfile for the NF producer further comprise: mapping the AccessTokenProfile for the NF Producer to the AccessToken for the NF consumer.

Aspect 5. The method of any of Aspects 1 to 4, wherein the mapping reflects a consumer identifier (ConsumerId) parameter, a producer identifier (ProducerId) parameter, and the TokenProfileId parameter for the NF Producer to the AccessToken and expiry for the NF Consumer.

Aspect 6. The method of any of Aspects 1 to 5, wherein the SCP stores a different AccessTokenProfile for each different NF Producer.

Aspect 7. The method of any of Aspects 1 to 6, further comprising: receiving, by the SCP, a second subsequent service request from the NF consumer to the NF producer, wherein the second subsequent servicer requests includes the same AccessTokenRequest parameters as the service request; and retrieving, by the SCP, the AccessToken for the subsequent service request based on the AccessTokenProfile.

Aspect 8. A system includes a storage (implemented in circuitry) configured to store instructions and a processor. The processor configured to execute the instructions and cause the processor to: generating, by a Network Function (NF) consumer, a token profile identifier (TokenProfileId) parameter for a set of access token request (AccessTokenRequest) parameters; sending, by the NF consumer, a service request for a NF producer to a service communication proxy (SCP), wherein the service request includes a set of network repository function (NRF) discovery parameters, the set of AccessTokenRequest parameters, and the TokenProfileId parameter; receiving, by the SCP, an access token (AccessToken) for the NF producer from a NRF based on the set of NRF discovery parameters and the set of AccessTokenRequest parameters; storing, in the SCP, the AccessToken for the NF consumer and an access token profile (AccessTokenProfile) for the NF producer; receiving, by the SCP, a subsequent service request from the NF consumer to the NF producer; and retrieving, by the SCP, the AccessToken for the subsequent service request based on the AccessTokenProfile.

Aspect 9. The system of Aspect 8, wherein the AccessTokenProfile includes a consumer identifier (ConsumerId) parameter, a producer identifier (ProducerId) parameter, and the TokenProfileId.

Aspect 10. The system of any of Aspects 8 to 9, wherein the subsequent service request includes the same set of AccessTokenRequest parameters as the service request.

Aspect 11. The system of any of Aspects 8 to 10, wherein the processor is configured to execute the instructions and cause the processor to: map the AccessTokenProfile for the NF Producer to the AccessToken for the NF consumer.

Aspect 12. The system of any of Aspects 8 to 11, wherein the mapping reflects a consumer identifier (ConsumerId) parameter, a producer identifier (ProducerId) parameter, and the TokenProfileId parameter for the NF Producer to the AccessToken and expiry for the NF Consumer.

Aspect 13. The system of any of Aspects 8 to 12, wherein the SCP stores a different AccessTokenProfile for each different NF Producer.

Aspect 14. The system of any of Aspects 8 to 13, wherein receiving, by the SCP, a second subsequent service request from the NF consumer to the NF producer, wherein the second subsequent servicer requests includes the same AccessTokenRequest parameters as the service request; and retrieving, by the SCP, the AccessToken for the subsequent service request based on the AccessTokenProfile.

Aspect 15. A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: generating, by a Network Function (NF) consumer, a token profile identifier (TokenProfileId) parameter for a set of access token request (AccessTokenRequest) parameters; sending, by the NF consumer, a service request for a NF producer to a service communication proxy (SCP), wherein the service request includes a set of network repository function (NRF) discovery parameters, the set of AccessTokenRequest parameters, and the TokenProfileId parameter; receiving, by the SCP, an access token (AccessToken) for the NF producer from a NRF based on the set of NRF discovery parameters and the set of AccessTokenRequest parameters; storing, in the SCP, the AccessToken for the NF consumer and an access token profile (AccessTokenProfile) for the NF producer; receiving, by the SCP, a subsequent service request from the NF consumer to the NF producer; and retrieving, by the SCP, the AccessToken for the subsequent service request based on the AccessTokenProfile.

Aspect 16. The computer readable medium of Aspect 15, wherein the AccessTokenProfile includes a consumer identifier (ConsumerId) parameter, a producer identifier (ProducerId) parameter, and the TokenProfileId.

Aspect 17. The computer readable medium of any of Aspects 15 to 16, wherein the subsequent service request includes the same set of AccessTokenRequest parameters as the service request.

Aspect 18. The computer readable medium of any of Aspects 15 to 17, wherein the processor is configured to execute the computer readable medium and cause the processor to: map the AccessTokenProfile for the NF Producer to the AccessToken for the NF consumer.

Aspect 19. The computer readable medium of any of Aspects 15 to 18, wherein the mapping reflects a consumer identifier (ConsumerId) parameter, a producer identifier (ProducerId) parameter, and the TokenProfileId parameter for the NF Producer to the AccessToken and expiry for the NF Consumer.

Aspect 20. The computer readable medium of any of Aspects 15 to 19, wherein the SCP stores a different AccessTokenProfile for each different NF Producer

What is claimed is:

1. A method comprising:
generating, by a Network Function (NF) consumer, a token profile identifier (TokenProfileId) parameter for a set of access token request (AccessTokenRequest) parameters;
sending, by the NF consumer, a service request for a NF producer to a service communication proxy (SCP), wherein the service request includes a set of network repository function (NRF) discovery parameters, the set of AccessTokenRequest parameters, and the TokenProfileId parameter;
receiving, by the SCP, an access token (AccessToken) for the NF producer from a NRF based on the set of NRF discovery parameters and the set of AccessTokenRequest parameters;
storing, in the SCP, the AccessToken for the NF consumer and an access token profile (AccessTokenProfile) for the NF producer;
receiving, by the SCP, a subsequent service request from the NF consumer to the NF producer; and
retrieving, by the SCP, the AccessToken for the subsequent service request based on the AccessTokenProfile.

2. The method of claim 1, wherein the AccessTokenProfile includes a consumer identifier (ConsumerId) parameter, a producer identifier (ProducerId) parameter, and the TokenProfileId.

3. The method of claim 1, wherein the subsequent service request includes a same set of AccessTokenRequest parameters as the service request.

4. The method of claim 1, wherein storing the AccessToken for the NF consumer and the AccessTokenProfile for the NF producer further comprise:
mapping the AccessTokenProfile for the NF Producer to the AccessToken for the NF consumer.

5. The method of claim 4, wherein the mapping reflects a consumer identifier (ConsumerId) parameter, a producer identifier (ProducerId) parameter, and the TokenProfileId parameter for the NF Producer to the AccessToken and expiry for the NF Consumer.

6. The method of claim 1, wherein the SCP stores a different AccessTokenProfile for each different NF Producer.

7. The method of claim 1, further comprising:
receiving, by the SCP, a second subsequent service request from the NF consumer to the NF producer, wherein the second subsequent servicer requests includes a same AccessTokenRequest parameters as the service request; and
retrieving, by the SCP, the AccessToken for the subsequent service request based on the AccessTokenProfile.

8. A system comprising:
a storage configured to store instructions; and
a processor configured to execute the instructions and cause the processor to:
generate, by a Network Function (NF) consumer, a token profile identifier (TokenProfileId) parameter for a set of access token request (AccessTokenRequest) parameters;
send, by the NF consumer, a service request for a NF producer to a service communication proxy (SCP), wherein the service request includes a set of network repository function (NRF) discovery parameters, the set of AccessTokenRequest parameters, and the TokenProfileId parameter;
receive, by the SCP, an access token (AccessToken) for the NF producer from a NRF based on the set of NRF discovery parameters and the set of AccessTokenRequest parameters;
store, in the SCP, the AccessToken for the NF consumer and an access token profile (AccessTokenProfile) for the NF producer;
receive, by the SCP, a subsequent service request from the NF consumer to the NF producer; and
retrieve, by the SCP, the AccessToken for the subsequent service request based on the AccessTokenProfile.

9. The system of claim 8, wherein the AccessTokenProfile includes a consumer identifier (ConsumerId) parameter, a producer identifier (ProducerId) parameter, and the TokenProfileId.

10. The system of claim 8, wherein the subsequent service request includes a same set of AccessTokenRequest parameters as the service request.

11. The system of claim 8, wherein the processor is further configured to execute the instructions and cause the processor to:
map the AccessTokenProfile for the NF Producer to the AccessToken for the NF consumer.

12. The system of claim 11, wherein the map reflects a consumer identifier (ConsumerId) parameter, a producer identifier (ProducerId) parameter, and the TokenProfileId parameter for the NF Producer to the AccessToken and expiry for the NF Consumer.

13. The system of claim 8, wherein the SCP stores a different AccessTokenProfile for each different NF Producer.

14. The system of claim 8, wherein the processor is further configured to execute the instructions and cause the processor to:
receive, by the SCP, a second subsequent service request from the NF consumer to the NF producer, wherein the second subsequent servicer requests includes a same AccessTokenRequest parameters as the service request; and
retrieve, by the SCP, the AccessToken for the subsequent service request based on the AccessTokenProfile.

15. A non-transitory computer readable medium comprising instructions, the instructions, when executed by a computing system, cause the computing system to:
generate, by a Network Function (NF) consumer, a token profile identifier (TokenProfileId) parameter for a set of access token request (AccessTokenRequest) parameters;
send, by the NF consumer, a service request for a NF producer to a service communication proxy (SCP), wherein the service request includes a set of network repository function (NRF) discovery parameters, the set of AccessTokenRequest parameters, and the TokenProfileId parameter;
receive, by the SCP, an access token (AccessToken) for the NF producer from a NRF based on the set of NRF discovery parameters and the set of AccessTokenRequest parameters;
store, in the SCP, the AccessToken for the NF consumer and an access token profile (AccessTokenProfile) for the NF producer;
receive, by the SCP, a subsequent service request from the NF consumer to the NF producer; and
retrieve, by the SCP, the AccessToken for the subsequent service request based on the AccessTokenProfile.

16. The computer readable medium of claim 15, the AccessTokenProfile includes a consumer identifier (ConsumerId) parameter, a producer identifier (ProducerId) parameter, and the TokenProfileId.

17. The computer readable medium of claim 15, the subsequent service request includes a same set of AccessTokenRequest parameters as the service request.

18. The computer readable medium of claim 15, wherein the computer readable medium further comprises instructions that, when executed by the computing system, cause the computing system to further:
map the AccessTokenProfile for the NF Producer to the AccessToken for the NF consumer.

19. The computer readable medium of claim 18, the mapping reflects a consumer identifier (ConsumerId) parameter, a producer identifier (ProducerId) parameter, and the TokenProfileId parameter for the NF Producer to the AccessToken and expiry for the NF Consumer.

20. The computer readable medium of claim 15, the SCP stores a different AccessTokenProfile for each different NF Producer.
